(19) United States
(12) Patent Application Publication
(10) Pub. No.: US 2025/0012372 A1
(43) Pub. Date: Jan. 9, 2025

(54) Armature Assembly Having a Throttle Module

(71) Applicant: KSB SE & Co. KGaA, Frankenthal (DE)

(72) Inventors: Gregor RAUCH, Frankenthal (DE); Dieter HANEWALD, Frankenthal (DE)

(21) Appl. No.: 18/710,654

(22) PCT Filed: Nov. 17, 2022
(86) PCT No.: PCT/EP2022/082287

§ 371 Date: May 16, 2024

(30) Foreign Application Priority Data
Nov. 17, 2021 (DE) 10 2021 129 947.0
Jan. 27, 2022 (DE) 10 2022 101 917.9
Jan. 27, 2022 (DE) 10 2022 101922.5

(51) Int. Cl. F16K 27/02; F16K 15/04

(52) U.S. Cl. CPC F16K 27/0209; F16K 15/042

(57) ABSTRACT

An armature assembly includes a casing and a throttle module. The casing has at least two openings and a channel. The throttle module, through which flow is configured to pass in a flow direction, is arranged in the channel. The throttle module has a flow chamber, in which a backflow preventer is arranged. The backflow preventer has an element and a stop for the element counter to the flow direction.

### CROSS REFERENCE TO RELATED APPLICATIONS

This application claims priority under 35 U.S.C. § 119 from German Patent Application No. 102021129947.0 dated Nov. 17, 2021, 102022101917.9 dated Jan. 27, 2022 and 102022101922.5 dated Jan. 27, 2022, the entire disclosures of which are herein expressly incorporated by reference.

### BACKGROUND

The disclosure relates to an armature assembly having a casing with at least two openings and a channel, wherein at least one throttle module, through which flow can pass in a flow direction, is arranged in the channel.

Such armature assemblies are usually used in systems for transporting fluids such as liquids, vapors or gases in order to be able to regulate or control the transport in a targeted manner. The armature assembly can also be completely shut off, as a result of which the transport of the fluid in question is interrupted.

Such armature assemblies are designed on the basis of safety-relevant aspects on the one hand and fluidic considerations on the other. For instance, the flow should be influenced only as little as possible in a fully open operating state. The influence is generally indicated in the form of a resistance coefficient or pressure loss coefficient. This coefficient is a measure of the pressure loss in a component through which flow passes and is usually represented by the dimensionless index zeta, which puts the pressure difference between the inlet and the outlet of the armature assembly in a ratio to the dynamic pressure.

Any disruption of the flow, for example in the form of a deflection or blockage of the channel, accordingly results in a pressure loss and consequently in an increase in the resistance coefficient. Known armature assembly designs such as ball cocks have very low resistance coefficients (zeta=0.11) in a fully open operating state, owing to the straight gate. Other designs, such as the globe valve, have much higher resistance coefficients (zeta=8.5) owing to the deflection of the flow.

However, the resistance coefficient is not the only criterion on which the design of an armature assembly is based. In particular if the armature assembly is used primarily for regulation purposes, it is necessary for a certain pressure difference to be brought about between the inlet and the outlet of the armature assembly when in a not fully open state. This pressure difference is achieved in that the throttle module limits the cross section of the channel depending on position. The limitation results in a reduction in the pressure.

The limitation of the cross section and thus also the influence on the flow is thus significantly dependent on the position of the throttle module and is usually described using characteristic curves that plot the throughflow against the position of the throttle module. Characteristic curves used as standard are linear characteristic curves in which equal relative distance changes lead to equal changes in the relative throughflow. Alternatively, equal percentage characteristic curves are known in which equal relative distance changes lead to an equal percentage change in the relative throughflow. Both linear and equal percentage characteristic curves are standard. They are equivalent.

These armatures with defined characteristic curves are used to regulate or control flow-conducting systems. However, an armature can assume a regulating function in a system only when the authority is high. This means that the armature significantly determines the pressure loss in a flow-conducting system. Accordingly, the greater the pressure loss achievable via the armature, the greater the authority. However, a problem here is that armature assemblies having high authority on the other hand also entail still very high resistance coefficients when in a fully open operating state. On the other hand, a flap, a slide valve or a cock, for example, do not have a high authority, i.e., they cannot be used well for regulation, but they also result in only a small pressure loss when in the fully open state.

Therefore, depending on the application and intended use, the selected resistance coefficient and thus the necessary authority resulting therefrom determine the design of the armature. The selected resistance coefficient defines the authority.

DE 10 2018 209 166 A1 presents an armature having a shutoff body, wherein the shutoff body has an element that is provided with a plurality of holes through which a medium flows. The flow cross-sectional areas within the holes vary. This variation in the flow cross section by the gate in the form of a hole allows the flow to be directed in a targeted manner. Damage to the walls of the armature or of the shutoff body resulting from cavitation or a deviating flow or turbulent swirls, which can also be referred to as abrasion, is thereby prevented in a targeted manner.

DE 10 2020 003 753 A1 discloses a valve having a valve casing with a throttle section in a channel, which is arranged movably. The channel has no bends, at least in the throttle section. The lack of bends in the throttle section ensures that the flow is not significantly deflected there.

DE 10 2020 003 756 A1 describes an armature assembly having a throttle section in a channel. The channel has a primary throttle module and a secondary throttle module. The secondary throttle module consists of at least a first and a second throttle element, wherein the throttle elements can be moved relative to one another such that in an operational state the flow resistance of a fluid flowing through changes depending on the position of the throttle elements. A variable setting of the resistance can thereby be achieved independently of the valve lift.

In order to ensure direction dependence in fluid flows, check armatures are used. A check armature is a component that permits the flow of a fluid in only one direction without providing further functions.

In spring-loaded check armatures, the closing element is closed by the spring in one direction but is opened by the pressure of the flowing fluid in the other direction. In this case, a ball, a cone, a flap or a diaphragm is pressed into the seal seat in question. If there is a pressure in the throughflow direction that can overcome the restoring force of the spring, the sealing element is lifted off from the seat and the throughflow is free.

In check armatures without a spring, the sealing element is pressed into the seal seat either by gravity or by the flow pressure of the flowing fluid.

### SUMMARY

Against this background, the object of the present disclosure is to specify an armature assembly that allows universal use, including avoiding backflow, in flow-conducting systems.

This object and other objects are achieved according to the disclosure by an armature assembly having a casing. Preferred variants can be found in further main claims, the dependent claims, the description and the drawings.

According to the disclosure, the throttle module has at least one flow chamber, in which at least one backflow preventer is arranged, wherein the backflow preventer has at least one element and a stop for the element counter to the flow direction.

A flow chamber means a chamber through which a fluid can flow and in the simplest case is similar to a channel-shaped line. The flow chamber is preferably designed for the throttle task to be carried out, so the flow chamber is adapted to this task in terms of the cross section, the length, the shape and the surface properties. The throttle module with the flow chamber is a complex component, which is preferably produced additively and as a result can have shapes that were previously difficult or impossible to produce by conventional manufacturing.

In a particularly preferred variant of the disclosure, the throttle module has a plurality of flow chambers. The throttle module can be designed as a structure with an extremely large number of flow chambers, which are for example small and complexly intertwined. Preferably, more flow chambers can be opened partially and gradually for flow to pass through, by moving parts of the armature assembly that are movable into one another, as a result of which the intended throttle task can be carried out efficiently.

In the variant having a plurality of flow chambers, a backflow preventer is particularly preferably arranged in each flow chamber. This ensures that the throttle module can guarantee a fluid flow in only one flow direction. A throttle module that can set a pressure difference over a large range and at the same time avoid reversal of the flow direction is very complex to produce in a conventional way or unknown until now. A favorable possibility is offered by additive manufacturing and the associated advantage of producing a plurality of extremely delicate channels. As a result, a complex throttle module having a plurality of flow chambers, including the backflow preventer in each flow chamber, can be achieved and at the same time an exact setting of the pressure difference over a large range can be realized.

Ideally, each flow chamber is designed as a channel through which flow can pass for this purpose. To this end, the flow chamber can be designed as a channel-like line. The flow chamber can have a round or rectangular or square or trapezoidal or polygonal or clover-leaf-shaped or a complexly shaped cross section.

In a particularly advantageous variant of the disclosure, the or each flow chamber is designed as a channel through which flow can pass, wherein the flow chamber preferably has a honeycomb structure. Such a honeycomb shape of the flow chamber can preferably have a hexagonal cross section. In an arrangement of many flow chambers next to one another, the hexagonal cross-sectional design offers an arrangement without gaps, as a result of which a maximum of fluid throughflow area and thus also a maximum of fluid throughflow can be realized.

Such cross-sectional shapes can advantageously be manufactured additively, since only round cross sections can be produced with conventional tools such as drills. In one variant of the disclosure, the cross-sectional shapes of the flow chamber can vary over the channel length to shape the throttle task.

In a particularly preferred variant of the disclosure, each flow chamber is designed as a curved channel. In this case, the flow chamber has a radial inlet opening and an axial outlet opening. Preferably, the fluid flows in radially and out axially. The flow chamber preferably has a complex shape, which can preferably be produced additively. Curved channels cannot be produced conventionally, for example using drills.

The backflow preventer ideally comprises all the components that are involved in and necessary for preventing and avoiding a reversal of flow.

A central constituent of the backflow preventer is an element. The element is preferably designed as a body. This body preferably takes the shape of a ball. Advantageously, the ball has an at least slightly larger diameter than the diameter of the flow chamber, as a result of which sealing can be ensured in the event of a reversal of flow.

In a further variant of the disclosure, the element of the backflow preventer can be designed as a flap, which interacts with a stop for sealing and for avoiding a reversal of the flow of the fluid.

In an alternative variant of the disclosure, the element of the backflow preventer can additionally comprise a spring element. Preferably, the element is combined with a spring element. Such a combination is preferably designed as a connection. To this end, the element including the spring element can be manufactured additively and simultaneously.

In a possible embodiment of the disclosure, the element is formed integrally with the spring element.

Advantageously, the spring element can be designed as a spiral spring or as a leaf spring.

Preferably, the spring element has a connection to the wall of the flow chamber or to the wall of the cavity. The element thereby receives a guide and is no longer freely movable within the flow chamber. Advantageously, the element can move with the flow exclusively on a guided path between the stop in the flow direction and the stop counter to the flow direction.

Ideally, additive manufacturing can be used to produce different spring stiffnesses adapted to the task of the backflow preventer.

In an alternative variant of the disclosure, the element can be designed as a cube or cuboid or truncated cone or pyramid or complex body, so that it interacts advantageously with the cross section of the flow chamber for sealing and for avoiding a backflow of the fluid.

Preferably, the backflow preventer has a stop for the element counter to the flow direction for sealing and avoiding a backflow. Ideally, the stop for the element counter to the flow direction comprises a stop face that is shaped as a negative of the element. Furthermore, the face around the stop can be shaped such that the element preferably finds a position on the stop and efficiently prevents a backflow.

In a particularly favorable variant of the disclosure, the backflow preventer has a stop for the element in the flow direction. Ideally, the element is positioned such that the fluid flow can flow around the element without flow separation and swirl.

Preferably, the stop for the element in the flow direction has a centering means, for example in the form of a bulge in the flow direction. The bulge is advantageously convex, as a result of which the element receives a defined position within the stop solely as a result of the flow of the fluid. In a particularly favorable variant of the disclosure, the element is designed as a spherical body and is positioned by the fluid in the part of the stop that bulges furthest outward as long as the fluid flows in the flow direction.

Ideally, the stop in the flow direction has strut-like elements, which interconnect in a star shape at a center point and thus form a flow divider. Preferably, three struts with a convex bulge, each arranged offset by 120°, form the stop in the flow direction. As a result, the element is positioned centrally within the stop, and the fluid can flow around the element without significant turbulence or pressure losses.

In an alternative variant of the disclosure, six struts with a convex bulge and an equal spacing from one another can also form the stop in the flow direction.

Preferably, the backflow preventer has a cavity. The cavity is a hollow chamber through which flow can pass and which is delimited by both stops. The cavity surrounds the element so that the element is arranged inside the cavity. The shape or structure of the hollow chamber through which flow can pass is adapted to the throttle task, in particular to the setting of the pressure difference, by the preferred, additive formation.

The cavity thus preferably extends from the stop counter to the flow direction to the stop in the flow direction. Depending on the arrangement of the backflow preventer, the flow chamber opens in the backflow preventer or originates from the backflow preventer, or the backflow preventer is arranged in a position within the flow chamber. The flow chamber and the backflow preventer thereby form a unit through which flow can pass.

In a particularly preferred variant, the backflow preventer is arranged at the end of the flow chamber as viewed in the flow direction. The backflow preventer is thus also accessible for post-machining if necessary.

Ideally, the element is enclosed in the cavity by means of integrative and thus additive manufacturing. During additive manufacturing, a cavity with two stops and in a complex shape adapted to the throttle task is formed around the simultaneously formed element.

In a preferred variant, the wall of the backflow preventer is produced in one part, and the element in the interior of the casing of the cavity has a larger diameter than the two stops, which can preferably be manufactured additively, in contrast to conventional manufacturing, in which a subsequent introduction of the element into the casing of the cavity is not possible in this way.

In an advantageous variant of the disclosure, the throttle module is formed integrally with at least one flow chamber, which comprises a backflow preventer in each case. Advantageously, the throttle module has a plurality of flow chambers. The walls of the flow chambers including the respective elements are shaped by integrative, additive manufacturing to form an integral throttle module.

Preferably, the cavity or the flow chamber is formed by an integral wall, and the element is integrated form-fittingly in the cavity.

This form-fitting integration is produced by interlocking the element and the cavity. As a result, the element cannot leave the cavity. Furthermore, the element would also not be able to be inserted into the cavity subsequently. In this respect, the wall of the cavity is in the way of the element at least so far that the element cannot leave the cavity.

This particular, form-fitting integration can preferably be achieved with the aid of additive manufacturing. In this case, the element and the wall of the cavity are formed simultaneously in one working step, as a result of which the removal and/or the subsequent insertion of the element are not possible.

Ideally, the wall of the cavity including the stops is formed integrally at the same time. As a result, the wall and each individual stop are preferably produced additively, in one operation and inseparably.

In a particularly preferred variant, a spherical element is embedded within a hollow chamber through which flow can pass, for example in the form of an oval pocket, delimited by a stop counter to the flow direction, into which the flow chamber opens, and further delimited by a stop in the flow direction in the form of a flow divider with three star-shaped struts.

In a favorable variant of the disclosure, the entire throttle module with the plurality of flow chambers, which each comprise a backflow preventer, is manufactured additively. The complex formation of the throttle module can be realized particularly advantageously for integration of the backflow preventer by means of additive manufacturing.

Ideally, the element and the wall of the flow chamber including at least one stop have a metallic surface. The metallic surfaces have an average roughness that can achieve sealing in terms of avoiding backflow. The spherical element lies so smoothly and sealingly in the stop that excellent sealing can be realized. The average roughness Ra is less than 6.4 μm, preferably less than 3.2 μm, in particular less than 1.6 μm.

The particularly smooth metallic surfaces are preferably achieved by electropolishing. The average roughness of the surfaces is reduced by electropolishing. Roughness peaks are removed more rapidly than roughness troughs, since, in electropolishing in mineral acid mixtures, a transport-limiting polishing layer that favors the removal of roughness peaks is formed before the surface. The nanoroughness is likewise reduced. In this case, the polishing is carried out electrochemically. The shine is a result of the roughness in the range of fractions of the wavelength of visible light.

Ideally, the average roughness of the metallic surfaces can be set in a targeted manner using the duration of the electropolishing and thus adapted to the task of the throttle module.

According to the disclosure, in the method for producing an armature assembly having a throttle module through which flow can pass, the element is produced in a cavity, at the same time as the cavity, by selectively exposing a construction material to radiation.

According to the disclosure, the throttle module is preferably additively manufactured. This particular manufacturing technology allows a flexible structure to be produced with extremely low use of material and very rapidly. In particular the element inside the cavity, with the element being movable inside the cavity to ensure fluid flow in only one preferred flow direction, can be achieved ideally by means of additive manufacturing technology.

An additively manufactured throttle module has been produced using an additive manufacturing method. The term additive manufacturing method includes all manufacturing methods in which material is applied layer by layer and thus three-dimensional elements, cavities and flow chambers are produced. The layer-by-layer construction takes place in a computer-controlled manner from one or more liquid or solid materials according to predefined dimensions and shapes. During construction, physical or chemical curing or melting processes take place. Typical materials for 3D printing are plastics, synthetic resins, ceramics, metals, and carbon and graphite materials.

Additive manufacturing methods mean methods in which material is applied layer by layer in order to produce a plurality of three-dimensional flow chambers in a throttle module. According to the disclosure, the backflow preventer is preferably designed to be additively manufactured. For the formation of the throttle module, in particular selective laser melting and cladding, also known as deposition welding, are used. In an alternative variant of the disclosure, extrusion in combination with the application of meltable plastic is also a method that can be used.

In selective laser melting, a flow chamber with a backflow preventer inside the throttle module is produced using a method in which a layer of a construction material is first applied to an underlayer. Preferably, the construction material for producing the flow chamber is metallic powder particles. In a variant of the disclosure, iron- and/or cobalt-containing powder particles are used for this purpose. These can contain additives such as chromium, molybdenum or nickel. The metallic construction material is applied in powder form in a thin layer to a plate. Then the pulverulent material is locally completely melted at the respectively desired points by means of radiation, and a solid material layer forms after solidification. Then the underlayer is lowered by the amount of a layer thickness, and powder is applied again. This cycle is repeated until all the layers are produced and the finished flow chamber or the finished throttle module is created.

The radiation used can be for example a laser beam, which generates the throttle module from the individual powder layers. The data for guiding the laser beam are generated on the basis of a 3D-CAD body by means of software. Alternatively to selective laser melting, an electron beam (EBN) can also be used.

In deposition welding or cladding, the throttle module is produced using a method that coats an initial piece by welding. Using a welding filler material in the form of a wire or a powder, deposition welding constructs a volume that realizes a particularly delicate and optimized shape of the throttle module.

In a particularly advantageous variant of the disclosure, the throttle module with flow chambers and backflow preventer is produced from a construction material by consecutive melting and solidification of layers by means of radiation. The different properties of the flow chamber, the cavity and the element and of the stops are generated by varying the radiation. A modification of the material properties is carried out already during construction by targeted control of the local heat input. This makes it possible to generate zones and microstructures of different material states of a chemically homogeneous material and thus different properties in a region of the throttle module.

In a variant of the disclosure, the throttle module can be formed from different construction material. The construction material preferably comprises metallic powder particles, in particular low-alloyed and/or high-alloyed steel powder particles and/or meltable plastic and/or a metal-polymer hybrid material.

In a variant of the disclosure, the throttle module is preferably produced using an additive manufacturing method in which a grid of points is applied from a meltable plastic onto a surface. By extrusion by means of a nozzle and subsequent curing by cooling at the desired position, a load-bearing construction is produced. The throttle module is usually constructed by repeatedly moving over a working plane line by line and then shifting the working plane upward in a stacking manner to produce the throttle module.

In a particularly advantageous variant of the disclosure, the armature assembly can at the same time fulfill a necessary regulation task by means of a primary throttle module.

The primary throttle module is preferably designed as a valve with a shutoff body and a valve seat, wherein the shutoff body moves in the flow direction and counter to the flow direction, respectively, when the valve is opened and closed.

Alternatively, the primary throttle module could also be designed with a ball cock, a flap or a slide valve as the shutoff body, in which case the shutoff body preferably moves perpendicularly to the flow direction.

According to the disclosure, the armature assembly is used to throttle a fluid with integrated prevention of backflow in a system through which flow can pass.

Further features and advantages of the disclosure can be found in the description of exemplary embodiments with reference to the drawings, and in the drawings themselves.

### BRIEF DESCRIPTION OF THE DRAWINGS

In the figures:

FIG. 1 shows a cross section of an exemplary embodiment of the armature assembly;

FIG. 2 shows a section through a backflow preventer; and

FIG. 3 shows a view of the stop in the flow direction with positioned element.

### DETAILED DESCRIPTION

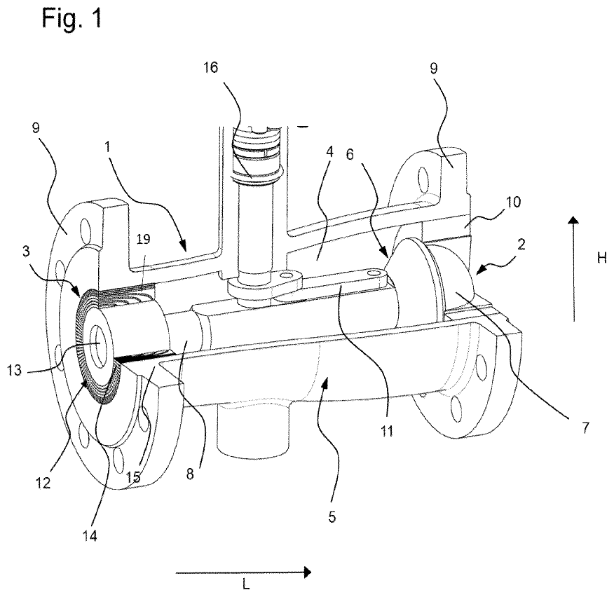

FIG. 1 shows an exemplary embodiment of the armature assembly, expressly not limited thereto, as a valve with a regulation task and a throttle function, wherein the throttle function is carried out by a primary throttle module 6 and a secondary throttle module 12.

The armature assembly has a casing 1, which can be installed at both ends via a flange 9 in each case in a flow-conducting system, for example pipelines. The flanges 9 have bores for receiving fastening means. These are preferably screw connections.

Provided in the casing 1 is a channel 4, which opens into a first and a second opening 2, 3 at the ends of the casing 1. In an operational state, the armature assembly is operated such that the first opening 2 is configured as an inlet opening and the second opening 3 is configured as an outlet opening for the flow. Accordingly, an operating medium flows counter to the channel direction L shown.

The channel 4 has no bends along the channel direction L. This means that a flow has no deflection caused by the casing and that the area center points of a cross-sectional area of the channel 4 are arranged at one height along the longitudinal direction L. This configuration means that in a fully open state of the armature assembly only a very small pressure loss is formed between the openings 2, 3. Although the channel 4 is formed without bends, it still widens from the second opening 3 in the channel direction L to just before the first opening 2, and then the channel 4 tapers to the first opening 2.

To throttle the armature assembly, a primary throttle module 6 consisting of a throttle head 7 and a drive rod 8 is arranged in a throttle section 5 of the channel 4 and can be moved in parallel relative to the throttle section 5 in the channel direction L. The throttle section 5 is formed without bends, and the armature assembly shown has no bends along the entire channel 4, as already explained.

The throttle head 7 is in the form of a parabolic cone and, in a fully closed state of the armature assembly, terminates sealingly with a valve seat. This valve seat is formed on a separate valve seat part 10, the valve seat part being arranged in the first opening 2. The narrowest point through which flow can pass in the armature assembly is always formed between the throttle head 7 and the valve seat part 10, so that, owing to the specific configuration of these components, the necessary pressure loss can be determined via the armature assembly depending on the position of the primary throttle module 6.

To set the position of the primary throttle module 6, or to be able to move the primary throttle module 6, the throttle head 7 is arranged at one end of the drive rod 8, and a section of the drive rod 8 is formed as a lifting kinematic system 11. The drive rod 8 forms the common primary throttle guide rail and the secondary throttle guide rail at the same time. The lifting kinematic system 11 has three slidably mounted structural elements. This lifting kinematic system 11 interacts with a rod drive 16, which is slidably mounted in the channel 4 and can be actuated from the outside. As a result, an external movement results in a linear movement of the primary throttle module 6 in or counter to the channel direction L. The direction of the movement depends on the rotation direction of the rod drive 16.

To actuate the rod drive 16, this is connected to a drive (not shown), wherein the primary throttle module 6 is moved between a fully closed position and a fully open position by rotation of the rod drive 16.

The drive rod 8 is arranged fully within the channel 4 and is guided linearly in or counter to the channel direction L via a secondary throttle module 12 and the throttle head 7. The secondary throttle module 12 can in principle be designed in different ways; in the example shown, the secondary throttle module 12 is realized via two throttle elements 13, 14 that can be moved relative to one another in the channel direction L, wherein the second throttle element 14 is fastened fixedly to the channel wall 15, and the first throttle element 13 is formed on a section of the drive rod 8. By moving the drive rod 8, the flow chambers 19 are partially opened or blocked in the secondary throttle module 12, so that the flow resistance changes depending on the position of the drive rod 8.

The throttle module 12 has a plurality of flow chambers 19, wherein most of the flow chambers 19 have a radial inlet opening and an axial outlet opening. The flow chambers 19 are thus formed as channels through which flow can pass and which are mostly designed as curved channels, in some cases also as channels through which flow can pass horizontally. A backflow preventer 20 is arranged in each flow chamber 19.

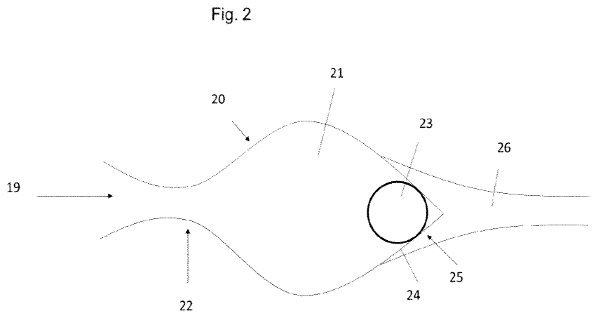

FIG. 2 shows a section through an exemplary backflow preventer 20. The backflow preventer 20 comprises a cavity 21 as a hollow chamber through which flow can pass and in which the element 23 is arranged. In this exemplary variant, the element 23 is designed as a ball.

The flow chamber 19 opens into the backflow preventer 20 via the stop 22 counter to the flow direction. The cavity 21 extends from the stop 22 counter to the flow direction to the stop 25 in the flow direction. The stop 25 in the flow direction is formed from strut-like elements 24, which have a bulge in the flow direction and thus hold the element 23 in a flow-optimized position when fluid flows through.

A flow outlet 26 adjoins the stop 25 in the flow direction. In the variant shown of the disclosure, the backflow preventer 20 is arranged at the end of the flow chamber 19 and thus at the flow outlet of the throttle module 12.

The element 23 is enclosed in the cavity 21 by additive manufacturing. During additive manufacturing, the cavity 21 is formed with two stops 22, 25 with simultaneous formation of the element 23 and has a shape adapted to the throttle task. Subsequent introduction of the element 23 into the cavity 21 is not possible, since the diameter of the element 23 is greater than the diameter of the two stops 22, 25, whereby the backflow preventer 20 in its complex shape can be produced well using additive manufacturing.

In the event of a reversal in the flow of the fluid, the element 23 is moved from the position in the stop 25 in the flow direction through the cavity 21 to the stop 22 counter to the flow direction and in the process closes the path for the fluid in the flow chamber 19. Backflow of the fluid is thereby prevented.

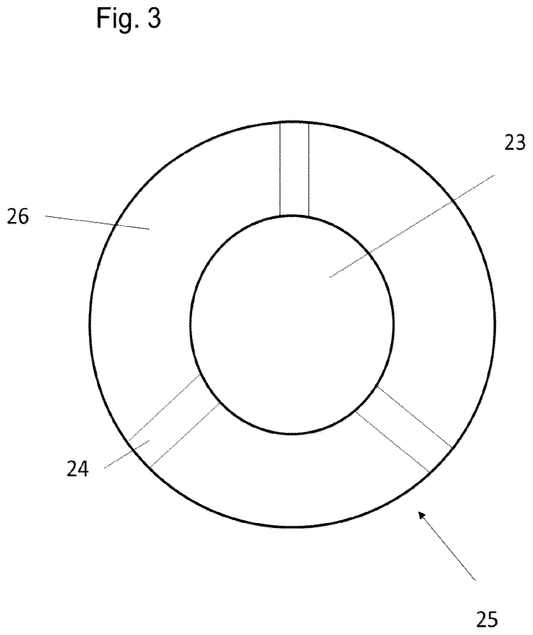

FIG. 3 shows an exemplary view of the stop 25 in the flow direction with positioned element 23. The stop 25 in the flow direction has three strut-like elements 24, which interconnect in a star shape at a center point and thus form a flow divider. The three strut-like elements 24 have a convex bulge in the flow direction and are each arranged offset by 120°. As a result, the element 23 is positioned centrally within the stop 25, and the fluid can flow around the element 23 without significant turbulence or pressure losses.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1.-16. (canceled)

17. An armature assembly comprising:
a casing with at least two openings and a channel; and
a throttle module, through which flow is configured to pass in a flow direction, that is arranged in the channel, wherein
the throttle module has a flow chamber, in which a backflow preventer is arranged, and
the backflow preventer has an element and a stop for the element counter to the flow direction.

18. The armature assembly as claimed in claim 17, wherein the throttle module has chambers.

19. The armature assembly as claimed in claim 18, further comprising: a backflow preventer that is arranged in each flow chamber.

20. The armature assembly as claimed in claim 19, wherein the flow chambers are structurally arranged to effect a parallel throughflow.

21. The armature assembly as claimed in claim 20, wherein each flow chamber is designed as a channel through which flow is configured to pass.

22. The armature assembly as claimed in claim 21, wherein each flow chamber is configured as a curved channel.

23. The armature assembly as claimed in claim 22, wherein the element is designed as a ball.

24. The armature assembly as claimed in claim 23, wherein the backflow preventer has a stop for the element in the flow direction.

25. The armature assembly as claimed in claim 24, wherein the stop has a centering structure in the flow direction.

26. The armature assembly as claimed in claim 25, wherein the stop has strut-like elements.

27. The armature assembly as claimed in claim 26, wherein the backflow preventer has a cavity.

28. The armature assembly as claimed in claim 27, wherein the element is enclosed in the cavity by integrative manufacturing.

29. The armature assembly as claimed in claim 12, wherein the throttle module is configured to be additively manufactured to integrate the backflow preventer.

30. The armature assembly as claimed in claim 29, wherein the element and the flow chamber with the stop have a metallic surface, the average roughness Ra of which is less than 6.4 μm.

31. The armature assembly as claimed in claim 29, wherein the average roughness Ra is less than 3.2 μm.

32. The armature assembly as claimed in claim 29, wherein the average roughness Ra is less than 1.6 μm.

33. A method for producing the armature assembly as claimed in claim 17, wherein the element is produced in a cavity by selectively exposing a construction material to radiation.

34. A method comprising:
using the armature assembly as claimed in claim 30 as a throttle assembly with integrated prevention of backflow in a system through which fluid flows.
